(19) United States
(12) Patent Application Publication
(10) Pub. No.: US 2013/0306215 A1
(43) Pub. Date: Nov. 21, 2013

(54) ADHESIVE TAPE ATACHING METHOD

(71) Applicant: DISCO CORPORATION, Tokyo (JP)

(72) Inventor: Mirei TOIDA, Tokyo (JP)

(73) Assignee: Disco Corporation, Tokyo (JP)

(21) Appl. No.: 13/887,518

(22) Filed: May 6, 2013

(30) Foreign Application Priority Data
May 15, 2012 (JP) 2012-111411

(51) Int. Cl. B29C 65/50

(52) U.S. Cl. CPC B29C 65/5064
USPC 156/60

(57) ABSTRACT

An adhesive tape attaching method including an aligning step of positioning the central portion of a wafer directly below the central portion of an adhesive tape, a partial attaching step of pressing the adhesive tape on the front side of the wafer by using an attaching roller positioned so as to cover the diameter of the adhesive tape passing through the central portion of the adhesive tape, thereby attaching a part of the adhesive tape to the wafer at a position where the central portion of the adhesive tape is superimposed on the central portion of the wafer, and an attaching step of rotationally moving the attaching roller from the central portion of the wafer to the radially opposite outer circumferential portions of the wafer after performing the partial attaching step, thereby attaching the adhesive tape to the wafer.

### BACKGROUND OF THE INVENTION

1. Field of the Invention

The present invention relates to an adhesive tape attaching method for attaching an adhesive tape to the front side of a wafer having a device area where a plurality of devices are formed and a peripheral marginal area surrounding the device area, the adhesive tape having an annular adhesive layer corresponding to the peripheral marginal area.

2. Description of the Related Art

In association with high-density packaging of semiconductor devices, bumps formed of solder or the like are used for bonding of a semiconductor chip to a substrate. For example, in the case of directly bonding the semiconductor chip to the substrate, ball-shaped bumps each having a diameter of about 100 μm are frequently used. A wafer having bumps formed on the front side is processed in such a manner that the back side of the wafer is ground to reduce the thickness of the wafer and the wafer is next divided to manufacture semiconductor chips each having the bumps on the front side.

In grinding the back side of the wafer to reduce the thickness of the wafer, an adhesive tape (protective tape) is attached to the front side of the wafer on which the bumps are provided, and the wafer is held on a suction holding surface or the like through the adhesive tape in the condition where the back side of the wafer is exposed. In this condition, the exposed back side of the wafer is ground. When each bump has a large height (e.g., about 100 μm in diameter), an area of the front side of the wafer where no bumps are provided is sucked onto the suction holding surface in the grinding operation, so that irregularities are generated on the back side of the wafer. In other words, the irregularities on the front side of the wafer due to the bumps have an effect on the back side of the wafer.

When irregularities are generated on the back side of the wafer as mentioned above, a load applied to the wafer in the grinding operation cannot be sufficiently absorbed by the cushioning property of the adhesive tape, causing a problem of damage to the wafer during the grinding operation or a problem of formation of a dimple (indentation on the back side of the wafer), which causes a reduction in reliability of each device obtained from the wafer. To cope with the problem of damage to the wafer, the finished thickness of the wafer after grinding is conventionally set to a relatively large thickness. In the case that a small finished thickness of the wafer is required, an adhesive tape having a thick adhesive layer (paste layer) is used to protect the front side of the wafer, wherein the thickness of the adhesive layer is set so as to accommodate the bumps formed on the front side of the wafer. Accordingly, grinding is performed in the condition where the bumps are embedded in the adhesive layer.

However, in the case of using such an adhesive tape having a thick adhesive layer in which the bumps are embedded, there is a problem such that the adhesive layer may be left as a residue on the bumps or the front side of each device after peeling the adhesive tape. To cope with this problem, there has been proposed a technique of using an adhesive tape having an annular adhesive layer corresponding to a peripheral marginal area surrounding a device area where devices are formed on the front side of the wafer. That is, the annular adhesive layer is located in only the peripheral marginal area of the wafer, and the bumps arranged at a relatively high density are used as a support member instead of the adhesive layer, so that the residue of the adhesive layer is not left after grinding the wafer (see Japanese Patent Nos. 4462997 and 4447280).

### SUMMARY OF THE INVENTION

However, in the case of attaching the adhesive tape having the annular adhesive layer to the wafer in the condition where the annular adhesive layer is properly located in only the peripheral marginal area of the wafer as a specified area without deviation, higher-accuracy alignment is required as compared with the case of attaching an adhesive tape having an adhesive layer adapted to be simply attached to the whole front side of the wafer.

It is therefore an object of the present invention to provide an adhesive tape attaching method which can locate the annular adhesive layer at an optimum position in the condition where the adhesive tape is attached to the wafer.

In accordance with an aspect of the present invention, there is provided an adhesive tape attaching method for attaching an adhesive tape to the front side of a wafer having a device area where a plurality of devices are formed and a peripheral marginal area surrounding the device area, the adhesive tape having an annular adhesive layer corresponding to the peripheral marginal area, the adhesive tape attaching method including: a wafer setting step of setting the wafer on a chuck table in the condition where the front side of the wafer is exposed; an aligning step of opposing the adhesive tape having the annular adhesive layer corresponding to the peripheral marginal area of the wafer to the front side of the wafer set on the chuck table and positioning the central portion of the wafer directly below the central portion of the adhesive tape, the adhesive tape being composed of a circular base having a diameter equal to that of the wafer and the annular adhesive layer formed on one side of the circular base along the outer circumference thereof; a partial attaching step of pressing the adhesive tape on the front side of the wafer by using an attaching roller positioned so as to cover the diameter of the adhesive tape passing through the central portion of the adhesive tape, thereby attaching a part of the adhesive tape to the wafer at a position where the central portion of the adhesive tape is superimposed on the central portion of the wafer; and an attaching step of rotationally moving the attaching roller from the central portion of the wafer toward the radially opposite outer circumferential portions of the wafer after performing the partial attaching step, thereby attaching the adhesive tape to the wafer.

In the condition where the adhesive tape having the annular adhesive layer is attached to the wafer, the annular adhesive layer can be located at an optimum position.

In the adhesive tape attaching method of the present invention, the central portion of the circular adhesive tape having the annular adhesive layer is first aligned to the central portion of the wafer and then superimposed thereon. Thereafter, the adhesive tape is pressed on the wafer by using the attaching roller so that the central portion of the adhesive tape is not misaligned to the central portion of the wafer (the partial attaching step). Thereafter, the attaching roller is rotationally moved from the central portion of the wafer (adhesive tape) to one of the radially opposite outer circumferential portions of the wafer (adhesive tape) (the attaching step). Thereafter, the attaching roller is further rotationally moved so as to attach the whole of the adhesive layer of the adhesive tape to the wafer. Accordingly, as compared with the conventional attaching method that the attaching roller is rotationally moved from one diametrical end of the wafer (adhesive tape) to the other diametrical end thereof in one stroke, the amount of misalignment between the central portion of the adhesive tape and the central portion of the wafer due to elongation of the adhesive tape can be reduced.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a wafer and an adhesive tape;

FIG. 2 is a perspective view of a tape supplying apparatus;

FIG. 3 is a sectional side view illustrating a positional relation between the wafer and the adhesive tape;

FIG. 4 is a perspective view showing a positional relation between an attaching roller and the wafer;

FIG. 5A is a partially sectional side view showing a positional relation between the attaching roller and the wafer;

FIG. 5B is a view similar to FIG. 5A, showing a partial attaching step;

FIG. 6 is a perspective view showing an attaching step; and

FIG. 7 is a sectional view showing a positional relation between a peripheral marginal area and an adhesive layer after the attaching step.

### DETAILED DESCRIPTION OF THE PREFERRED EMBODIMENT

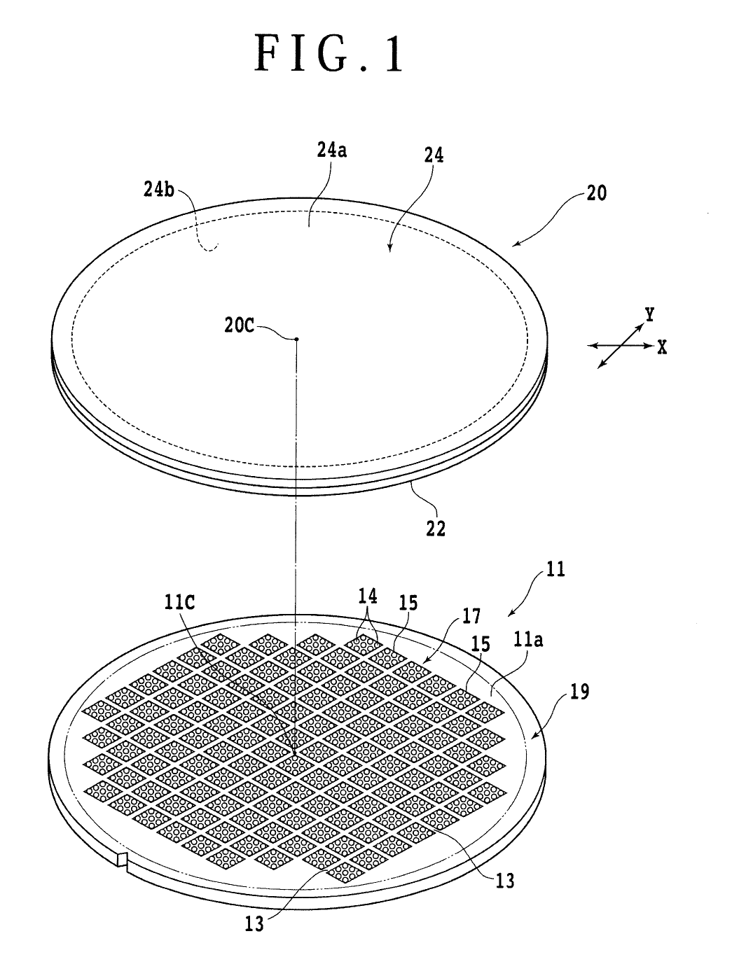

As shown in FIG. 1, the present invention relates to an adhesive tape attaching method for attaching an adhesive tape 20 to the front side 11a of a wafer 11 having a device area 17 where a plurality of devices 15 are formed and a peripheral marginal area 19 surrounding the device area 17, the adhesive tape 20 having an annular adhesive layer 22 corresponding to the peripheral marginal area 19.

As shown in FIG. 1, the wafer 11 as a workpiece is a circular silicon wafer having a thickness of 700 μm, for example. A plurality of crossing division lines (streets) 13 are formed like a lattice on the front side 11a of the wafer 11 to thereby partition a plurality of regions where the plural devices 15 are respectively formed. A plurality of bumps 14 as electrodes are provided on the front side of each device 15. As described above, the wafer 11 has the device area 17 where the devices 15 are formed and the annular peripheral marginal area 19 surrounding the device area 17 on the front side 11a.

The shape of the wafer 11 as a workpiece is not limited to a circular shape shown in FIG. 1, but a quadrangular shape such as a rectangular shape and a square shape is also assumed. In the case that the wafer 11 has a quadrangular shape, the peripheral marginal area 19 of the wafer 11 is assumed to have a quadrangular ring shape. Further, the wafer 11 as a workpiece is not limited to a semiconductor wafer, but an optical wafer may be used. Each device 15 of the wafer 11 may not have the bumps 14. Further, irregularities may be formed on the front side of each device 15 in addition to the bumps 14 or in place of the bumps 14.

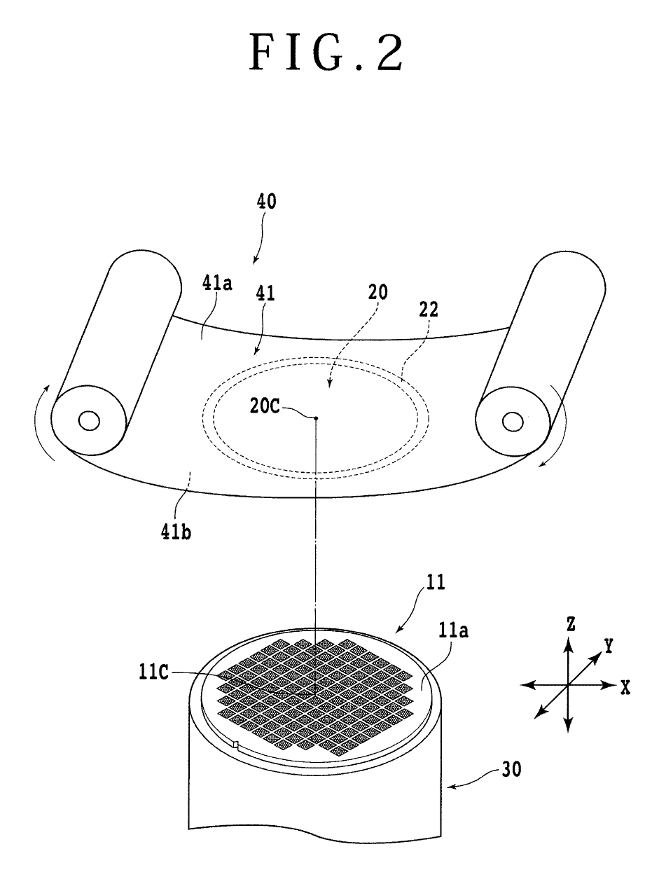

The adhesive tape attaching method according to the present invention as applied to the wafer 11 will now be described. As shown in FIG. 2, a wafer setting step is performed in such a manner that the wafer 11 is set on a chuck table 30 in the condition where the front side 11a of the wafer 11 is exposed. The upper surface of the chuck table 30 functions as a holding surface for holding the back side of the wafer 11 under suction. The wafer 11 is held on the holding surface of the chuck table 30 in the condition where the front side 11a of the wafer 11 is oriented upward, or exposed.

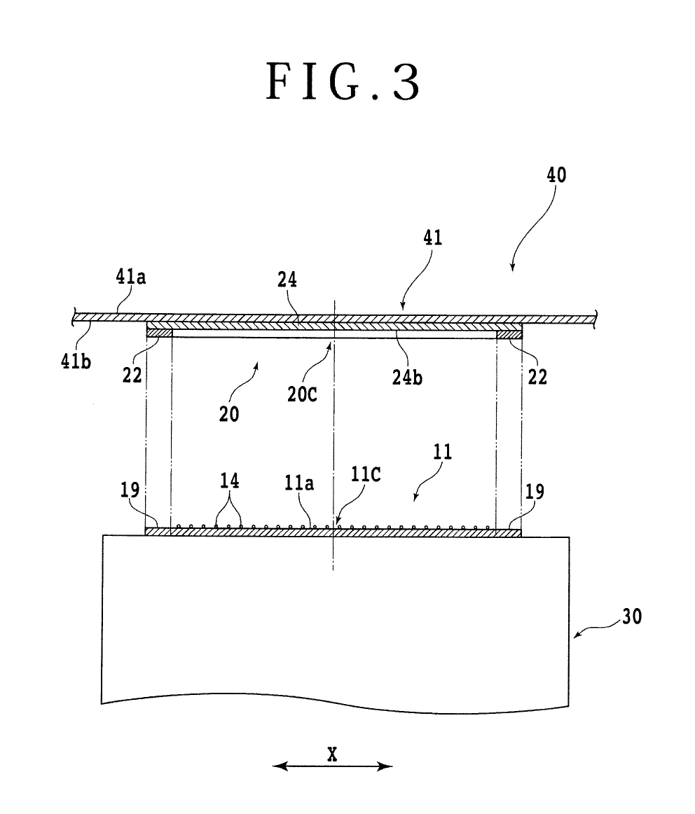

After performing the wafer setting step mentioned above, an aligning step is performed as shown in FIGS. 1 to 3 in such a manner that the adhesive tape 20 having the annular adhesive layer 22 corresponding to the peripheral marginal area 19 of the wafer 11 is opposed to the front side 11a of the wafer 11 set on the chuck table 30 and that the central portion 11C of the wafer 11 is positioned directly below the central portion 20C of the adhesive tape 20, the adhesive tape 20 being composed of a circular base 24 having a diameter equal to that of the wafer 11 and the annular adhesive layer 22 formed on one side of the circular base 24 along the outer circumference thereof. In this preferred embodiment, the base 24 has the same shape and size as those of the wafer 11 as viewed in plan, and the annular adhesive layer 22 is formed on the back side 24b (see FIG. 3) of the base 24. The adhesive tape 20 is aligned with the wafer 11 so that the adhesive layer 22 is positioned directly above the peripheral marginal area 19 of the wafer 11. The base 24 is not especially limited. For example, the base 24 may be provided by a base sheet formed of a soft resin such as polyolefin and having a thickness of about 70 to 200 μm. Further, the adhesive layer 22 may be formed by annularly applying an adhesive with a thickness of about 5 to 100 μm to the back side 24b of the base 24.

The adhesive tape 20 is supplied by a tape supplying apparatus 40 for continuously supplying a plurality of similar adhesive tapes 20. These plural adhesive tapes 20 are supported on the back side 41b of a rolled release paper 41 so as to be arranged at intervals in the longitudinal direction of the release paper 41. Any one of the plural adhesive tapes 20 is supplied by suitably unwinding the rolled release paper 41 so that the back side 24b of the base 24 of the adhesive tape 20 is opposed to the chuck table 30. The tape supplying apparatus 40 is positioned so that the center position of the chuck table 30 coincides with the center position of the adhesive tape 20 in the Y direction. Further, the tape supplying apparatus 40 is operated to suitably unwind the rolled release paper 41 so that the center position of the chuck table 30 coincides with the center position of the adhesive tape 20 in the X direction. As a modification, an imaging apparatus for detecting the center position of the chuck table 30 and the center position of the adhesive tape 20 may be provided to suitably perform alignment of the chuck table 30 and the adhesive tape 20 in the case of misalignment between these center positions.

In the aligning step mentioned above, the back side 24b of the base 24 of the adhesive tape 20 is opposed to the front side 11a of the wafer 11 set on the chuck table 30, and the central portion 11C of the wafer 11 is positioned directly below the central portion 20C of the adhesive tape 20. The wording of “the central portion 20C of the adhesive tape 20” means a concept including the center position of the base 24 of the adhesive tape 20, and the wording of “the central portion 11C of the wafer 11” means a concept including the center position of the wafer 11. This aligning step is performed in order to align the adhesive layer 22 of the adhesive tape 20 with the peripheral marginal area 19 of the wafer 11. In this preferred embodiment, the adhesive tape 20 and the wafer 11 have circular shapes with the same diameter. Accordingly, by aligning the central portion 20C of the adhesive tape 20 with the central portion 11C of the wafer 11, the adhesive layer 22 can be aligned with the peripheral marginal area 19 with high accuracy.

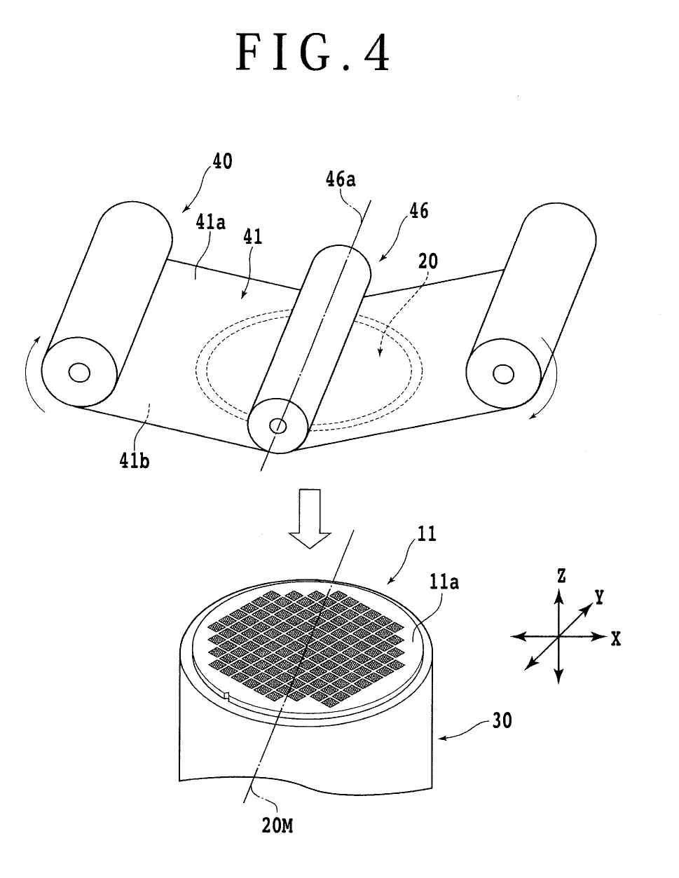

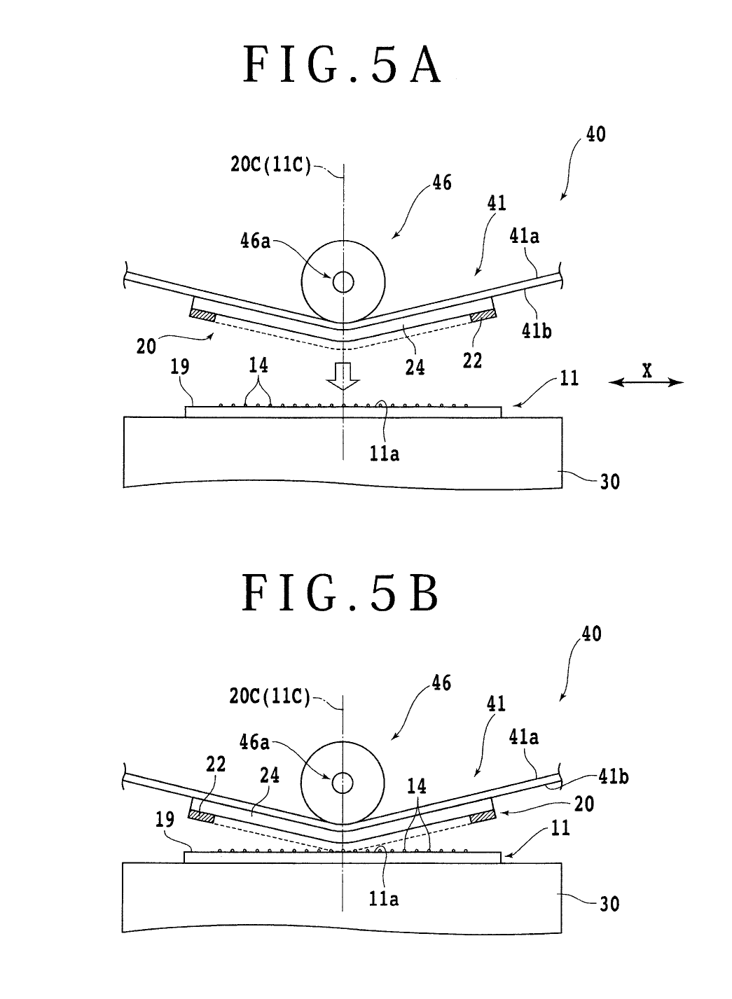

After performing the aligning step mentioned above, a partial attaching step is performed as shown in FIGS. 4, 5A, and 5B in such a manner that the adhesive tape 20 is pressed on the front side 11a of the wafer 11 by using an attaching roller 46 positioned so as to cover the diameter of the adhesive tape 20 passing through the central portion 20C of the adhesive tape 20, thereby attaching and fixing a part of the adhesive tape 20 to the wafer 11 at a position 20M where the central portion 20C of the adhesive tape 20 is superimposed on the central portion 11C of the wafer 11.

The attaching roller 46 is arranged so as to come into contact with the front side 41a of the release paper 41 and press the adhesive tape 20 supported on the back side 41b of the release paper 41 against the wafer 11. The attaching roller 46 is rotatable about its axis 46a. The rotation axis 46a of the attaching roller 46 is positioned so as to cover the diameter of the adhesive tape 20, i.e., so as to pass through the central portion 20C of the adhesive tape 20 (the central portion 11C of the wafer 11). Accordingly, as shown in FIG. 5A, all of the rotation axis 46a of the attaching roller 46, the central portion 20C of the adhesive tape 20, and the central portion 11C of the wafer 11 are arranged in a line as viewed in side elevation (at the same position in the X direction).

In this condition, the attaching roller 46 is lowered as shown in FIG. 5B to attach a part of the adhesive layer 22 of the adhesive tape 20 to the front side 11a of the wafer 11 in the condition where the central portion 20C of the adhesive tape 20 is superimposed on the central portion 11C of the wafer 11. Since the adhesive layer 22 of the adhesive tape 20 has been aligned with the peripheral marginal area 19 of the wafer 11 in the aligning step mentioned above, a part of the adhesive layer 22, i.e., a portion of the adhesive layer 22 positioned just below the attaching roller 46 is attached to a corresponding portion of the peripheral marginal area 19 of the wafer 11.

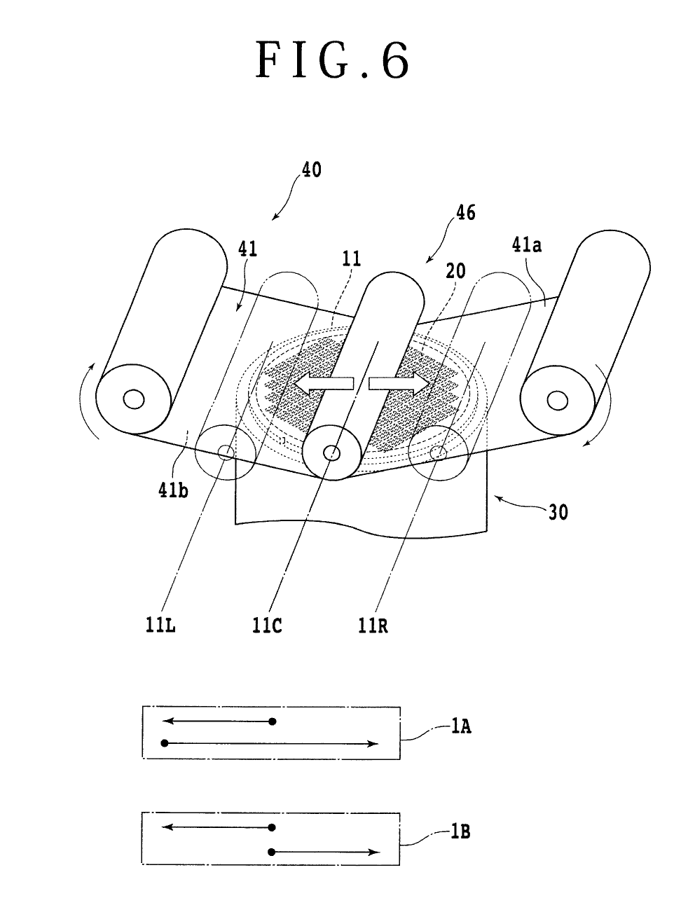

After performing the partial attaching step mentioned above, an attaching step is performed as shown in FIG. 6 in such a manner that the attaching roller 46 is rotationally moved from the central portion 11C of the wafer 11 toward the radially opposite outer circumferential portions 11L and 11R of the wafer 11, thereby attaching the adhesive tape 20 to the wafer 11. In the condition obtained by the preceding partial attaching step, the adhesive tape 20 is pressed on the wafer 11 by the attaching roller 46 so as to avoid misalignment between the central portion 20C of the adhesive tape 20 and the central portion 11C of the wafer 11. Accordingly, in moving the attaching roller 46 from the central portion 11C of the wafer 11 toward the outer circumferential portions 11L and 11R in the attaching step, it is possible to suppress the occurrence of misalignment between the central portions 20C and 11C due to elongation of the adhesive tape 20 (the base 24).

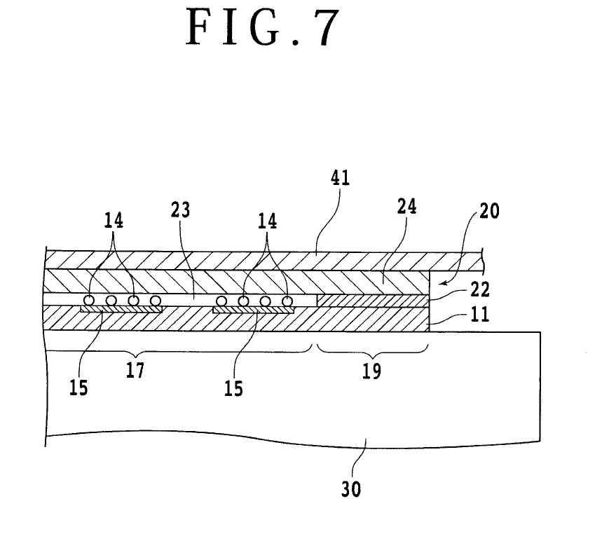

Since the occurrence of misalignment between the central portions 20C and 11C can be suppressed as mentioned above, the occurrence of misalignment between the adhesive layer 22 and the peripheral marginal area 19 can be suppressed. Accordingly, in the condition where the adhesive tape 20 having the annular adhesive layer 22 is attached to the wafer 11 as shown in FIG. 7, the annular adhesive layer 22 can be located at an optimum position, i.e., at a position corresponding to the peripheral marginal area 19. In the case that the attaching roller 46 is moved from one diametrical end (the outer circumferential portion 11L) of the wafer 11 (the adhesive tape 20) to the other diametrical end (the outer circumferential portion 11R) of the wafer 11 in one stroke, the distance traveled by the attaching roller 46 is long, so that when the adhesive tape 20 (the base 24) is elongated during the travel of the attaching roller 46, misalignment between the central portions 20C and 11C may occur. As a result, the adhesive layer 22 may be located at a position deviated from the peripheral marginal area 19.

The path of the rotational movement of the attaching roller 46 is not especially limited, but it is essential that the attaching roller 46 is moved from a position corresponding to the central portion 11C of the wafer 11 toward the outer circumferential portions 11L and 11R. For example, a path 1A shown in FIG. 6 may be adopted. That is, the path 1A is a path where the attaching roller 46 is moved from the central portion 11C through the outer circumferential portion 11L to the outer circumferential portion 11R. Further, a path 1B shown in FIG. 6 may also be adopted. That is, the path 1B is a path where the attaching roller 46 is once moved from the central portion 11C to the outer circumferential portion 11L, next returned to the central portion 11C, and next moved again from the central portion 11C to the outer circumferential portion 11R.

By adopting such a path to move the attaching roller 46 from the central portion 11C toward the outer circumferential portions 11L and 11R, the misalignment between the central portions 20C and 11C can be suppressed to the half or less as compared with the case that the attaching roller 46 is moved from the outer circumferential portion 11R to the outer circumferential portion 11L in one stroke. Accordingly, the misalignment between the adhesive layer 22 and the peripheral marginal area 19 can be suppressed.

Further, as shown in FIG. 7, the device area 17 of the wafer 11 is surrounded by the annular adhesive layer 22, and the bumps 14 formed on the front side of each device 15 are accommodated in a space 23 defined inside the annular adhesive layer 22. Accordingly, there is no possibility that the adhesive layer 22 may adhere to the bumps 14 and that the residue of the adhesive layer 22 may be left on the front side of each device 15 after peeling the adhesive tape 20.

If the misalignment between the central portions 20C and 11C is large, there arises a problem that the adhesive layer 22 may be located in the device area 17 and come into contact with the bumps 14 in the configuration shown in FIG. 7, so that the residue of the adhesive layer 22 may be left on the front side of each device 15 after peeling the adhesive tape 20. In the case that the bumps 14 formed on the front side of each device 15 are arranged at a relatively high density as shown in FIG. 7, the bumps 14 may be used as a support member in a subsequent step of grinding the back side of the wafer 11.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. An adhesive tape attaching method for attaching an adhesive tape to a front side of a wafer having a device area where a plurality of devices are formed and a peripheral marginal area surrounding the device area, the adhesive tape having an annular adhesive layer corresponding to the peripheral marginal area, the adhesive tape attaching method comprising:
a wafer setting step of setting the wafer on a chuck table in the condition where the front side of the wafer is exposed;
an aligning step of opposing the adhesive tape having the annular adhesive layer corresponding to the peripheral marginal area of the wafer to the front side of the wafer set on the chuck table and positioning a central portion of the wafer directly below a central portion of the adhesive tape, the adhesive tape being composed of a circular base having a diameter equal to that of the wafer and the annular adhesive layer formed on one side of the circular base along the outer circumference thereof;
a partial attaching step of pressing the adhesive tape on the front side of the wafer by using an attaching roller positioned so as to cover the diameter of the adhesive tape passing through the central portion of the adhesive tape, thereby attaching a part of the adhesive tape to the wafer at a position where the central portion of the adhesive tape is superimposed on the central portion of the wafer; and
an attaching step of rotationally moving the attaching roller from the central portion of the wafer toward the radially opposite outer circumferential portions of the wafer after performing the partial attaching step, thereby attaching the adhesive tape to the wafer.
